(19) United States
(12) Patent Application Publication
(10) Pub. No.: US 2024/0073207 A1
(43) Pub. Date: Feb. 29, 2024

(54) USER AUTHENTICATION

(71) Applicant: BRITISH TELECOMMUNICATIONS PUBLIC LIMITED COMPANY, London (GB)

(72) Inventors: Gabriele GELARDI, London (GB); Max SMITH-CREASEY, London (GB); Gery DUCATEL, London (GB)

(21) Appl. No.: 18/256,439

(22) PCT Filed: Nov. 25, 2021
(86) PCT No.: PCT/EP2021/083049

§ 371 Date: Jun. 8, 2023

(30) Foreign Application Priority Data
Dec. 8, 2020 (GB) 2019297.7

(51) Int. Cl. H04L 9/40

(52) U.S. Cl. CPC H04L 63/0861; H04L 63/107

(57) ABSTRACT

A computer implemented method for authenticating a user, the method including receiving an authentication request from a first computer system, the authentication request including an indication of an identity of the user to be authenticated; receiving one or more authentication factors for verifying the identity of the user, the one or more authentication factors including at least one authentication factor obtained from a second computer system associated with the user having the indicated identity; receiving an auxiliary authentication factor, the auxiliary authentication factor comprising data for verifying that the second computer system is currently in the possession of the user having the indicated identity; and verifying the identity of the user based on the one or more authentication factors and the auxiliary authentication factor.

### PRIORITY CLAIM

The present application is a National Phase entry of PCT Application No. PCT/EP2021/083049, filed Nov. 25, 2021, which claims priority from GB Patent Application No. 2019297.7, filed Dec. 8, 2020, each of which is hereby fully incorporated herein by reference.

### TECHNICAL FIELD

The present disclosure relates to authentication of a user. In particular, the present disclosure relates to the use of behavioral biometrics as an authentication factor in a multi-factor authentication scheme.

### BACKGROUND

Various authentication schemes for authenticating users are known. In general, to authenticate themselves to a remote computer system, a user must supply an indication of their identity by which they are known to that system (such as a username or email address), together with one or more pieces of evidence (otherwise known as authentication factors, or simply factors) to prove that they are in fact the user having that identity.

Simple authentication systems may only require a single piece of evidence (or authentication factor) to be provided, such as a password that is only known to the user and which can be verified as being that user's password by the system with which they are authenticating.

More secure authentication systems may require more than one piece of evidence to be provided (and are therefore referred to as multi-factor authentication schemes). For example, two-factor authentication schemes, which are commonly deployed to protect more sensitive computer systems, require two pieces of evidence to be provided. These schemes typically require the user to provide something they know (which may be referred to as a ‘knowledge factor’), as well as evidence that they are in possession of a particular object (which may be referred to as a ‘possession factor’).

For example, Automatic Teller Machines (ATMs) or “cashpoint” terminals, which are provided by banks and other service-providers for users to access banking services and obtain money, typically require users to provide a physical card associated with their account (i.e. ‘a possession factor’) and enter a Personal Identification Number (PIN) (i.e. a ‘knowledge factor’).

As a further example, online services which deal with more sensitive information, such as email accounts, may require that a user enters a password (i.e. a ‘knowledge factor’) and a so-called one-time password (OTP) that is to be used in conjunction with the authentication request at that particular point in time. The mechanism by which the OTP is obtained by the user to provide with the authentication request is intended to provide evidence that they are in possession of a particular object (i.e. it is a ‘possession factor’). For example, some systems send a code to a user's mobile phone to be used with a particular authentication attempt. Therefore, the code should only be accessible to someone in possession of the user's mobile phone. Other systems make use of an algorithm to generate a OTP from a secret token that is securely implanted (or stored) in a computer system belonging to the user (such as the user's mobile phone) at some time in advance of an authentication attempt (such as when the user registers for a particular service). For example, the time-based one-time password (TOTP) algorithm can generate a password that changes periodically (typically every 30 seconds) based on an underlying secret token and the current date/time at which the authentication attempt is occurring. Provision of the OTP therefore provides evidence that the person providing the OTP is in possession of the device in which the secret token was implanted (since it is unlikely they would be able to correctly generate the OTP otherwise).

### SUMMARY

Existing multi-factor authentication schemes that rely on demonstrating possession of an object, such as a mobile phone, as an authentication factor (i.e. which make use of a ‘possession factor’) suffer from a weakness associated with the possibility that an attacker may be able to gain physical access to that object, thereby circumventing the additional security provided by such schemes. For example, an attacker may target a particular user by stealing their mobile phone in order to gain access to any of their user accounts that are protected through the use of that mobile phone as a ‘possession factor’ for authentication.

In a first aspect of the present disclosure, there is provided a computer implemented method for authenticating a user. The method receives an authentication request from a first computer system. The authentication request comprises an indication of an identity of the user to be authenticated. The method further receives one or more authentication factors for verifying the identity of the user. The one or more authentication factors comprise at least one authentication factor obtained from a second computer system associated with the user having the indicated identity. The method further receives an auxiliary authentication factor, the auxiliary authentication factor comprising data for verifying that the second computer system is currently in the possession of the user having the indicated identity. The method further verifies the identity of the user based on the one or more authentication factors and the auxiliary authentication factor.

Through the provision of the auxiliary authentication factor, the above noted problems associated with existing multi-factor authentication schemes that rely on demonstrating possession of an object (i.e. the second computer system, such as a mobile phone), as an authentication factor can be overcome. In particular, the auxiliary authentication factor enables a determination to be made as to whether the object being used as a ‘possession factor’ is still in the possession of the correct user. This improves the security of any system protected by such an authentication scheme because an attacker would not only need to steal the object (such as a user's mobile phone) that is being used as an authentication factor, but would also need to be able to imitate other characteristics of the user. This makes an attacker's task significantly more difficult.

The method may further request the auxiliary authentication factor in response to determining that the authentication request is associated with a level of risk that exceeds a predetermined threshold.

The determination that the authentication request is associated with a level of risk that exceeds a predetermined threshold may be based on either one or both of: a time of the request; and a location of the request.

The data provided with the auxiliary authentication factor may comprise data derived from one or more behavioral biometrics.

Behavioral biometrics can be collected without requiring any dedicated input from the user (that is to say, without requiring input from the user that is solely for the purpose of authenticating) and so are particularly suited to implementing embodiments of the disclosure as the enable, the additional security to be provided without introducing additional inconvenience to the user.

The data may be, at least partially, derived from measurements of the one or more behavioral biometrics for a current user of the second computer system and the auxiliary authentication factor may be, at least partly, received from the second computer system.

The data may be, at least partially, derived from respective measurements of the one or more behavioral biometrics for a respective current user of one or more further computer systems associated with the user having the identity indicated by the authentication request.

The auxiliary authentication factor may be, at least partly, received from each of the one or more further computer systems.

The one or more further computer systems associated with the user having the indicated identity may be located within a predetermined vicinity of the second computer system.

The method may further: identify the one or more further computer systems associated with the user having the indicated identity that are located within a predetermined vicinity of the second computing device; send requests for the auxiliary authentication factor to each of the further computer systems, wherein the auxiliary authentication factor is received in response to the requests and includes data from each of the further computer systems.

The data may comprise an indication of an identity of a current user of a computer system as determined by a continuous authentication mechanism operating on that computer system.

The data may comprise a respective indication of a confidence in the identity of the current user of the computer system.

The verification of the identity of the user is further based on a sensitivity level associated with the authentication request, the sensitivity level indicating a required level of confidence in the identity of the user that is required for the identity indicated in the authentication request to be verified.

The at least one authentication factor obtained from the second computer system may be received from the first computer system.

The at least one authentication factor obtained from the second computer system may be received from the second computer system.

The authentication of the user may be for controlling access to a resource, the method may further comprise allowing access to the resource in response to verifying the identity of the user.

In a second aspect of the present disclosure, there is provided a computer implemented method for authenticating a user to a remote computer system. The method provides an auxiliary authentication factor for use by the remote computer system to verify an identity of the user indicated in an authentication request from a first computer system based on one or more authentication factors and the auxiliary authentication factor. The one or more authentication factors comprise at least one authentication factor obtained from a second computer system associated with the user having the indicated identity. The auxiliary authentication factor comprises data for verifying that the second computer system is currently in the possession of the user having the indicated identity.

The method may be performed by the second computer system and the auxiliary authentication factor may be provided to the remote computer system.

The method may further provide the at least one authentication factor to the remote computer system.

The data comprises data derived from one or more behavioral biometrics.

The method may further: identify one or more further computer systems associated with the user having the indicated identity that are located within a predetermined vicinity of the second computer system; send requests for the auxiliary authentication factor to each of the further computer systems; and receive, from each of the further computer systems, in response to the requests, data derived from respective measurements of the one or more behavioral biometrics for a current user of that computer system, wherein the data provided for the auxiliary authentication factor is based, at least in part, on the data received from the one or more further computer systems.

The data provided for the auxiliary authentication factor may be based, at least in part, on data derived from measurements of the one or more behavioral biometrics for a current user of the second computer system.

The method may be performed by a further computer system in response to a request for an auxiliary authentication factor to be provided. The request may be received from the remote computer system and the auxiliary authentication factor is provided to the remote computer system. Alternatively, the request may be received from the second computer system and the auxiliary authentication factor is provided to the second computer system.

The data of the auxiliary authentication factor may be generated by a continuous authentication mechanism and the data may optionally comprise an identity of a current user of the computer systems as determined by the continuous authentication mechanism for that computer system.

In a third aspect of the present disclosure, there is provided a computer system comprising a processor and a memory storing computer program code for carrying out the method of the first or second aspects.

In a fourth aspect of the present disclosure, there is provided a computer program which, when executed by one or more processors, is arranged to cause the processors to carry out the method of the first or second aspects.

### BRIEF DESCRIPTION OF THE DRAWINGS

Embodiments of the present disclosure will now be described by way of example only, with reference to the accompanying drawings, in which:

FIG. 1 is a block diagram of a computer system suitable for the operation of embodiments of the present disclosure.

FIG. 2 is a block diagram of an arrangement of computer systems in which embodiments of the disclosure may operate.

FIG. 3 is a flowchart that schematically illustrates a method for authenticating a user.

FIG. 4 is a flowchart that schematically illustrates a method for authenticating a user to a remote computer system.

### DETAILED DESCRIPTION

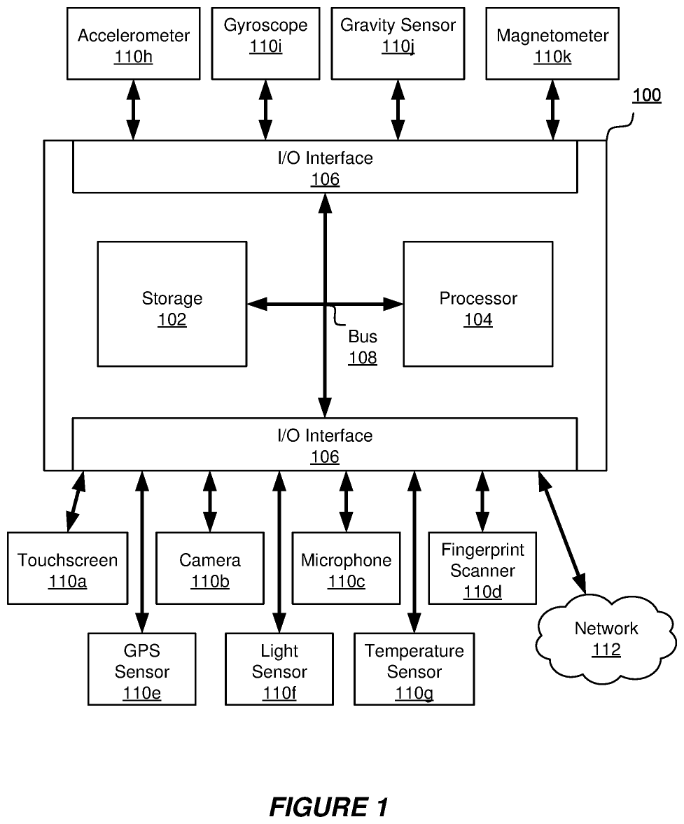

FIG. 1 is a block diagram of a computer system (or device) 100 suitable for the operation of embodiments of the present disclosure. The system 100 comprises a storage 102, a processor 104 and one or more input/output (I/O) interfaces 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage device in the hierarchy providing differing capacities and response times, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs are computer programs which, when executed by the processor 104, cause the processor 104 to carry out a method according to an embodiment of the disclosure (and accordingly configure the system 100 to be a system 100 according to an embodiment of the disclosure). The processor 104 may comprise multiple processing cores, either contained in a single chip or distributed across multiple chips (i.e. the processor 104 may be a multiprocessor), as is known in the art.

The one or more input/output (I/O) interfaces 106 provide interfaces to devices 110 for the input or output of data, or for both the input and output of data. The devices 110 that are connected to the system 100 via the interfaces 106, interfaces 106 may include one or more devices that are intended to either obtain input from a user or provide input to a user, or both. For example, a touchscreen 110a may be connected to the system 100 to provide information to the user via images output to the touchscreen's display and allow the user to provide input by touching or swiping different points on the touchscreen 110a. However, in alternative embodiments, the touchscreen may be replaced by, or augmented with one or more of: a keyboard, a mouse, a number pad and a non-touchscreen display. The devices 110 that are attached to the system 100 via the I/O interfaces may further include one or more sensors that provide an input based on sensed parameters of the physical environment in which the system 100 is operating. For example, the devices 110 may include one or more of: a camera 110b, a microphone 110c, a fingerprint scanner 110d, a GPS sensor 110e, a light sensor 110f, a temperature sensor 110g, an accelerometer 110h, a gyroscope 110i, a gravity sensor 110j and a magnetometer 110k. Although any other sensor may be used instead or in addition, as will be appreciated by those skilled in the art. The one or more input/output (I/O) interfaces 106 may further include one or more network interfaces to enable the computer system 100 to communicate with other computer systems via one or more networks 112. As will be appreciated, any suitable type of network 112 may be utilized by computer system 100 to communicate with other computer systems, including communication via both wired and wireless media, such as, for example, Bluetooth, WiFi or mobile communications networks.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of the disclosure. As examples, the computer system 100 could comprise one or more of a personal computer; a laptop; a tablet; a mobile telephone (or smartphone); an Internet of Things (IoT) device; and a server. The devices 110 that interface with the computer system 100 may vary considerably depending on the nature of the computer system 100 and may include devices not explicitly mentioned above, as would be apparent to the skilled person.

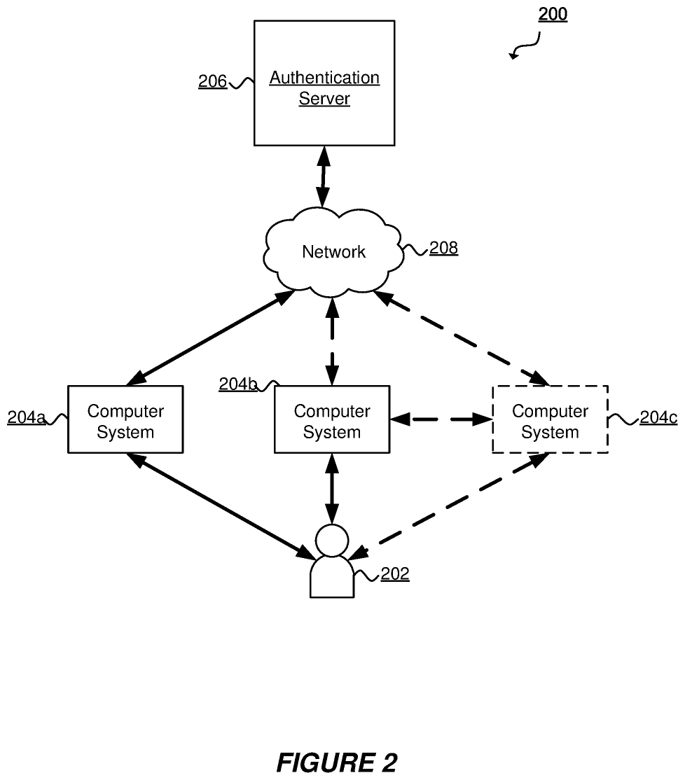

FIG. 2 is a block diagram of an arrangement 200 of computer systems 100 in which embodiments of the disclosure may operate.

In this arrangement 200, a user 202 may interact with one or more computer systems 204, including a first computer system 204a and a second computer system 204b. In some embodiments, the user 202 may interact with one or more further computer systems 204, that is to say with computer systems 204 other than the first computer system 204a or second computer system 204b, such as with a third computer system 204c. As discussed above the computer systems 204 that the user 202 interacts may be any kind of computer system 100. For example, the first computer system 204a could be a laptop, the second computer system 204b could be a tablet computer and the third computer system 204c could be a smartphone, although it will be appreciated that any other combinations of different types of computer systems 100 could be used instead.

The first computer system 204a is communicatively coupled to an authentication server 206 via a network 208. The second computer system 204b may also be communicatively coupled to the authentication server 206 via the network 208 (or via a different network). In this case, the communications between the second computer system 204b and the authentication server 206 may pass over a different communication channel 210 than the communications between the first computer system 204a and the authentication server 206. Specifically, the communications from the first computer system 204a may be sent via a first communication channel, whilst the communications from the second computer system 204b may be sent via a second communication channel. Similarly, the one or more further computer systems, such as the third computer system, may each be communicatively coupled to the authentication server 206 via respective further communication channels. For example, the third computer system 204c may communicate with the authentication server 206 via a third communication channel. However, as will be apparent from the following discussion of the disclosure, it is not necessary for both the second computer system 204b and the further computer systems, such as the third computer system 204c, to be directly communicatively coupled to the authentication server 206 via their own respective communication channels.

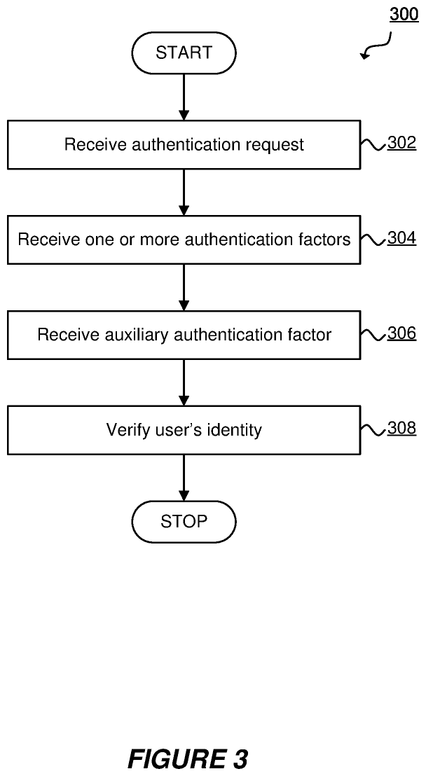

FIG. 3 is a flowchart that schematically illustrates a method 300 for authenticating a user, such as user 202. The method 300 may be performed by authentication server 206 to verify the identity of a user. Such verification of a user identity may be required before allowing the user to carry out some action. For example, the authentication server 206 may be used to control access to a resource, such as data, a service, a network, or other computer systems. In which case, the authentication server 206 may allow (or enable) access to the resource once it has verified the identity of the user (assuming, of course, that the user having that identity is permitted to access the resource). It will be appreciated that such an access control mechanism may be implemented as part of the authentication server 206, or as other software modules operating on the same computer system as authentication server 206, or indeed through interaction between the authentication server 206 and other computer systems that collectively implement the access control mechanism.

At an operation 302, the method 300 receives an authentication request from the first computer system 204a. The authentication request comprises an indication of an identity for the user to be authenticated. As will be understood by those skilled in the art, the identity serves to identify a particular user within the system that the authentication request is attempting to authenticate. The authentication server 206 can use this identity to retrieve authentication data for that user, for example from a user credentials database, which can be used to verify whether the party sending the request is in fact the user that they claim to be (i.e. the user identified by the authentication request). There are many different types of identifier that may be used to indicate an identity of a user. As examples, usernames, email addresses, membership numbers and/or telephone numbers can be used as identifiers. However, any other suitable identifier that can uniquely identify a user may be used instead. In some cases, a system may store multiple identifiers for each user, such as storing both a username and an email address. In such cases, the authentication request may only include a single identifier, such as only providing one of their username or email address.

The authentication request may be sent by the first computer system 204a in order to initiate the authentication with the authentication server 206. Alternatively, the authentication request may be sent by the first computer system 204a in response to receiving an authentication challenge from the authentication server 206 (for example when trying to access a resource requiring authentication) and may involve multiple discrete messages being passed between the first computer system 204a and first computer system 204a. Nonetheless, the authentication request indicates to the authentication server 206 an identity of the user of the first computer system 204a which is to be verified by the authentication server 206.

At an operation 304, the method 300 receives one or more authentication factors for verifying the identity of the user. The one or more authentication factors comprise at least one authentication factor which has been obtained from a second computer system associated with the user having the indicated identity. In general terms, the authentication factor that is obtained from the second computer system 204b serves to provide proof that the second computer system is in the possession of the user. As discussed above, this type of authentication factor may be referred to as a ‘possession factor’. For example, the second computer system 204b may be configured to provide a one-time password (OTP) that is generated from a secret stored on the second computer system 204b which serves as this ‘possession factor’.

The authentication factor that is obtained from the second computer system 204b may be received by the authentication server 206 from the first computer system 204a. For example, the user 202 may view the OTP generated by the second computer system 204b and input it into the first computer system 204a for transmission to the authentication server 206. In such cases, this authentication factor may be provided as part of the authentication request (in which case operations 302 and 304 may effectively be combined), or may be provided separately later on, for example in response to a message from the authentication server 206 requesting that this authentication factor be provided.

Alternatively, the authentication factor that is obtained from the second computer system 204b may be received by the authentication server 206 directly from the second computer system 204b, via a separate communication channel. For example, the user 202 may indicate to the second computer system 204b that they wish to send this authentication factor in order to authenticate themselves and the second computer system 204b may send the OTP to the authentication server 206. As will be appreciated, the sending of this authentication factor may be initiated by the user 202 or may be performed in response to a notification triggered by a communication received by the second computer system 204b from the authentication server 206.

In any case, at operation 304, one or more authentication factor, including at least one ‘possession factor’ obtained from the second computer system 204b is received.

At an operation 306, the method 300 receives an auxiliary authentication factor. The auxiliary authentication factor comprises data which enables verification of whether that the second computer system 204b is currently in the possession of the user being authenticated (that is to say, the user having the identity indicated in the authentication request). This data may be derived from measurements of one or more behavioral biometrics.

Behavioral biometrics are based on relatively invariant features of a user's behavior as they carry out various activities. As an example, behavioral biometrics may be extracted from a user's interactions with a device, such as by swiping or tapping a touch screen, or typing on a keyboard or moving a mouse. Other activities may be unrelated to interaction with the device, but can be sensed by the device when it is carried by the user, such as whilst walking or speaking with the device in their possession. A particular user will have various traits, such as their keystroke and mouse movement dynamics (e.g. typing rate and patterns) or their gait when walking. These traits can be detected through measurements from various sensors attached to a computer system 100. For example, touchscreen interaction, such as swipes or taps, can be detected via a touchscreen 110a of the computer system 100. The data provided by the touchscreen 110a may therefore yield various features that can help to distinguish a particular user from other users. For example, the pressure applied, stroke length and/or duration of any touchscreen interactions may be measured and are likely to be different for different users, yet consistent for a particular user. Other sensors may yield other behavioral biometrics. For example, information retrieved from sensors, such as an accelerometer 110h, gyroscope 110i, gravity sensor 110j and/or magnetometer may be used to determine other distinguishing features of a particular user, such as their gait when walking, or the way in which they hold their phone (e.g. a typical device orientation). As a further example, tapping or typing patterns on a keyboard (either virtual or physical)) may be monitored and behavioral biometrics relating to this patterns (which may be referred to as keystroke dynamics) can be used. Similarly, the semantic content of data entered into the phone (whether by virtual or physical keyboard or by voice via a microphone 110c, or in any other way), may be analyzed to determine linguistic behavioral biometric relating to patterns in the language that is used by the user to express themselves (for example, frequencies of use of different words). All these features are considered to be behavioral biometrics. It will be appreciated that there are a wide range of different behavioral biometrics that may be used. Any form of suitable behavioral biometric that can help distinguish one user from another (either alone or in combination with other behavioral biometrics) and which may be sensed by the computing device 100 may be used.

In general, there are two different approaches to using behavioral biometrics for authentication. Firstly, behavioral biometrics may be used to positively identify a particular user. That is to say, an identity for the current user may be determined based solely on measurements of their behavioral biometrics. Secondly, behavioral biometrics may be used to verify that a particular user is currently in possession of a computer system. That is to say, given a particular user identity, it can be verified that the behavioral biometrics match those expected when that user is using the device. As will be appreciated, an individual behavioral biometric can be used for this second type of authentication (i.e. to confirm whether a particular user is in possession of a computer system). For example, the typing rate or gait of the current user may be compared with the known typing rate or gait of that particular user to see whether there is any discrepancy that would indicate that the current user is not the particular user. However, individual behavioral biometrics might not be able to sufficiently discriminate between users in a manner which would allow a particular user to be identified from a single behavioral biometric (i.e. using the first approach to behavioral biometric authentication). For example, several users may have the same (or very similar) typing rates, making it impossible to identify an individual user from their typing rate. Nonetheless, as will be understood by those skilled in the art, by combining a sufficient number of appropriately chosen behavioral biometrics, individual users may be identified. Similarly, through the use of multiple behavioral biometrics, the confidence in the verification of a particular user identity may also be increased regardless of which approach is taken.

In order to determine the identity of a user of a device through their behavioral biometrics, or to verify that a particular user is currently using the device, machine learning techniques, such as Support Vector Machine (SVM), can be trained based both on genuine user data and on generic impostor data. The models that are produced by such techniques effectively embody a behavioral biometric profile for the user which can be used to determine whether (or not) a set of measurements of behavioral biometrics correspond with that user's use of the computer system.

As with other applications of behavioral biometrics, it is necessary to generate the measurements of the behavioral biometrics in a manner which yields repeatable results and yet still provides some utility for distinguishing particular users from other users (when multiple behavioral biometrics are combined). The skilled person would be readily familiar with techniques for doing this. For example, the granularity (or accuracy) with which each behavioral biometric is measured may be lowered to ensure that repeated measurements are likely to provide the same result at the level of granularity that is chosen. Similarly, measurements may be classified into broader categories that the measurements belong to and each such category may be associated with a particular value. Additionally, normalization techniques may be used to normalize the data that is provided by the sensors. For example, multiple measurements of a particular feature may be averaged to provide an average measurement for that feature (such as an average speed of touch, or an average length of stroke and so on). Similarly, data from other sensors may be used to normalize the data that is read from another sensor (e.g. data from a gravity sensor 110j may be used to normalize data from an accelerometer 110h so that it is relative to a “real world” coordinate system rather than being relative to the computing device 1000. The skilled person would be readily familiar with these, as well as other, techniques that may be used to ensure that the measurements of the behavioral biometrics are captured in a manner which is repeatable.

The use of behavioral biometrics as an authentication factor can provide an advantage over using other types of authentication factors, such as knowledge factors (e.g. passwords) or the use of other types of inherent factors such as most types of physiological biometrics (e.g. fingerprints). This is because behavioral biometrics can be measured whilst the user goes about their usual activities and do not require the user to specific input that is solely dedicated to authentication. For example, a knowledge factor such as a password requires the user to enter that password into the computer system. Similarly a physiological factor such as a fingerprint requires the user to press their finger to a fingerprint scanner. Therefore, providing such authentication factors necessarily interrupts a user's activity while they provide the necessary input into the computer system. By contrast, behavioral biometrics can be measured whilst a user goes about their ordinary activities, either when actively using the device or when simply carrying it about. This means that an authentication factor that is based on behavioral biometrics, such as the auxiliary authentication factor received at operation 306, can be obtained at any given point in time without inconveniencing the user. This means that behavioral biometrics are also suitable for use as part of continuous authentication mechanisms which may operate on one or more of the computer systems 204. Such continuous authentication mechanisms may operate continuously (or at least periodically or sporadically) to maintain an up-to-date determination of the identity of the current user of the computer systems based on measurements of behavioral biometrics resulting from their current (or at least more recent) interactions with the computer system. Although the foregoing discussion notes that most types of physiological biometrics cannot be obtained without requiring dedicated input from the user, it will be appreciated that there are some physiological biometrics which are capable of being measured without requiring dedicated input (i.e. they can be passively captured). For example, a forward facing camera on a mobile phone may capture an image of the user's face without requiring specific input from the user this can be used for facial recognition to provide a physiological biometric without requiring dedicated input from a user. Therefore, such physiological biometrics, which can be detected passively and do not require specific dedicated interaction from the user, are also suitable for use with the presently claimed disclosure. Such suitable physiological biometrics may also be used by the continuous authentication mechanism which is utilized by certain embodiments of the disclosure. Accordingly, whilst the remainder of the discussion of the disclosure focuses on the use of behavioral biometrics, it will be appreciated that in some cases, certain suitable physiological biometrics may be used as the basis for the data provided by the auxiliary authentication factor either instead of or in addition to the use of behavioral biometrics.

The auxiliary authentication factor may comprise data derived from measurements of the one or more behavioral biometrics for a current user of the second computer system. That is to say, the behavioral biometrics are obtained from the same computer system that is being used as the ‘possession factor’ for verifying the identity of the user. As will be appreciated, this provides a direct way of checking that the second computer system is in fact currently in the possession of the correct owner and has not been obtained by an unauthorized user.

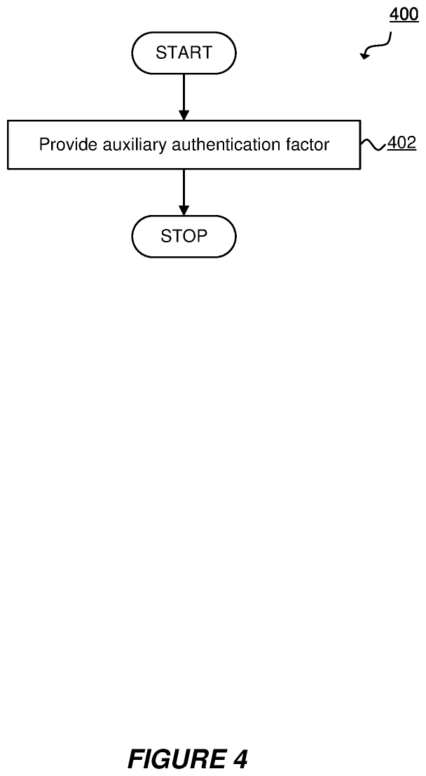

However, in some cases, the auxiliary authentication factor may additionally or alternatively comprise data derived from the measurements of the one or more behavioral biometrics from one or more further computer systems that are associated with the user, such as the third computer system 204c. This data enables verification that each of the one or more further computer systems are currently in the possession of the correct owner (i.e. the same user that is the correct owner of the second computer system). An assumption may be made that a user will commonly lose multiple computer systems at the same time (such when a bag containing a mobile phone, tablet and laptop is stolen). Therefore, it may be considered that it the second computer system 204b (i.e. the possession factor) is in the possession of the correct owner if other computer systems also belonging to that owner are in the owner's possession. Conversely, if one or more computer systems belonging to the owner are currently in someone else's possession, there may be an increased risk that the second computer system 204b is also not in their possession. Accordingly, this data from the one or more further computer systems may be used in conjunction with the data from the second computer system 204b to provide better confidence that the second computer system 204b is in the correct owner's possession. Alternatively, this data may be used instead of any data from the second computer system 204b, such as when behavioral biometric data cannot be obtained from the second computer system 204b.

Where the auxiliary authentication factor comprises data derived from behavioral biometric measurements taken by the second computer system 204b, the auxiliary authentication factor is, at least partly, received from the second computer system 204b. That is to say, the second computer system 204b may provide the auxiliary authentication facto to the authentication server 206 via the second communication channel.

Where the auxiliary authentication factor comprises data derived from behavioral biometric measurements taken by one or more further computer systems, the auxiliary authentication factor may still be received from the second computer system 204b That is to say, the second computer system 204b may collect the data from the one or more further computer systems and forward it on to the authentication server 206 via the second communication channel. However, in other cases, the auxiliary authentication factor may be received from each of the one or more further computer systems. That is to say, each of the one or more further computer systems may provide the auxiliary authentication factor (or a portion thereof) to the authentication server 206 via respective communication channel associated with that further computer system. Accordingly, in cases where no behavioral biometric-related data is obtained from the second computer system, the auxiliary authentication factor may be entirely received from the one or more further computer systems. As will be appreciated from this discussion, different portions of the auxiliary authentication factor may be separately received from different computer systems or may be entirely received from an individual computer system, such as either the second computer system 204b or the third computer system 204c.

Where the auxiliary authentication factor comprises behavioral biometric-related data from one or more further computer systems that are associated with the user, the method 300 may restrict the further computer systems that are used to computer systems that are located within a particular predetermined vicinity of the second computer system 204b. This can improve the strength of the assumption that current possession of the one or more further computer systems reflects the current ownership of the second computer system 204b, since it means that the further computer systems are currently co-located with the second computer system 204b and so are even more likely to be in the possession of the same user (whether that is the correct owner of the computer systems or not). The predetermined vicinity may be a certain distance, such as being within 1, 2, 5, 10, 25 or 50 meters of the second computer system 204b. Alternatively, the predetermined vicinity may be determined as being within communication range of the second computer system 204b via a short-distance communication technology such as Bluetooth or being connected to the same network (e.g. being connected to the same WiFi hotspot). Suitable further computer systems from which the behavioral biometric-derived data for the auxiliary authentication factor can be gathered may be identified either by the authentication server 206 as part of the method 300, or by second computer system 204b as part of providing the auxiliary authentication factor (as will be discussed in more detail in relation to FIG. 4 below). For example, the authentication server 206 may identify one or more further computer systems associated with the user identified by the authentication request that are located within a predetermined vicinity of the second computing device. This may be achieved by communicating with computer systems that are known to be associated with the user 202 and determining whether they are in the vicinity of the second computer system 204b. For example, the authentication server 206 may query each computer system known to be associated with the user 202 to obtain a GPS coordinate of the computer systems. This may then be compared with a GPS coordinate of the second computer system 204b and used to obtain a subset of the user's computer systems that are within a predetermined distance of the second computer system 204b. Alternatively, the authentication server may communicate with each of the computer systems known to be associated with the user 202 to identify those computer systems that are in communication range of the second computer system 204b via a short-distance communication technology such as Bluetooth. Having identified the one or more further computer systems that are within the predetermined vicinity of the second computer system 204b, the authentication server 206 may send a request to each such computer system requesting that they send the auxiliary authentication factor (which may be considered to be a portion of the auxiliary authentication factor when the auxiliary authentication factor comprises portions that are received from multiple computer systems). The one or more further computer systems may then each provide an authentication factor comprising data based on measurements of the behavioral biometrics for a current user of that computer system.

In some cases, the data that is derived from one or more behavioral biometrics may comprise an indication of an identity of a current user of a computer system as determined by a continuous authentication mechanism operating on the computer system that provided the data. That is to say the second and/or further computer systems may be configured to continuously authenticate their current user on the basis of their behavioral biometrics. An indication of the identity determined by such mechanisms may then be provided as the auxiliary authentication factor from that computer system. This indication of an identity of a current user may also be accompanied by an indication of a confidence in that identity being the correct identity for the current user (although this is not necessary). As will be appreciated, the machine learning model that is trained to identify or verify the user may additionally provide this confidence measure. However, it will be appreciated, that generally the confidence may be higher when more behavioral biometric measurements are available and conform to the behavioral biometric profile of a particular user and lower when fewer behavioral biometric measurements are available and conform less well to the behavioral biometric profile of the particular user.

In other cases, the measurements of the behavioral biometrics themselves may be provided with the auxiliary authentication factor, in which case the authentication server can verify the identity of the current user of the second and/or further computer systems for itself.

At an operation 308, the method 300 verifies the identity of the user 206 based on the one or more authentication factors and the auxiliary authentication factor. In particular, the method 300 uses the authentication factor obtained from the second computer 204b together with the auxiliary authentication factor to verify that not only does the authenticating user have access to the second computer system 204b (i.e. the possession factor), but that they are the user to whom the second computer system 204b belongs. Therefore, the auxiliary authentication factor serves to provide an additional authentication factor that serves to strengthen a multi-factor authentication scheme. Accordingly, when embodiments of the disclosure are used to enhance a standard two-factor authentication scheme, the auxiliary authentication factor serves to effectively create a more secure three-factor authentication scheme. Furthermore, since no explicit user input is required for the auxiliary authentication factor to be provided, this additional security can be provided without any further inconvenience being caused to the user 202.

In some cases, the authentication server 206 may require that the auxiliary authentication factor be provided as standard with every authentication attempt. However, in other cases, a risk assessment may be performed to determine whether the authentication request is associated with a level of risk that exceeds a predetermined threshold. If the authentication is considered risky (i.e. the level of risk associated with it exceeds the threshold), then the authentication server may request that the auxiliary authentication factor is provided so that the more secure authentication process can be performed. Meanwhile for lower risk authentication requests (i.e. where the associated level of risk is below the threshold), the authentication may be performed using a one or more authentication factor authentication scheme, as standard (i.e. without the use of the auxiliary authentication factor). For example, the authentication server may evaluate the level of risk associated with a particular authentication request based on a time of day that it is received and/or a location of the computer system from which it was received. Where the user identified in the authentication request typically only carries out activity requiring authentication at certain times of day and/or in particular locations (such as when connected to particular networks) and the authentication request is received outside of such times of day and/or locations, it may be determined that the level of risk associated with the authentication request is above this threshold. Similarly, where the authentication request is received from a computer system that is new to the user 202 (i.e. where the user 202 has not previously used the first computer system 204a), the authentication request may be considered more risky than where the authentication request is received from a computer system that the user 202 has previously used. Therefore, in such situations where the authentication request is considered to be risky (i.e. associated with a level of risk exceeding the predetermined threshold), the authentication server may request that the auxiliary authentication factor is also provided in order to provide additional security.

Similarly, the verification of the identity of the user that is performed at operation 308 may further take into consideration a sensitivity level associated with the authentication request. This sensitivity level indicates a required level of confidence in the identity. Only if this level of confidence is met should the authentication request be considered to be verified. Otherwise, the authentication request should be considered unverified. This sensitivity level may be determined for example based on the sensitivity of the resource being accessed for which authentication is required. In general, the more sensitive the resource, the higher the confidence in the determined identity should be before it can be accessed. Alternatively, where a level of risk is associated with the request, the sensitivity level may additionally or alternatively reflect the level of risk of the authentication request. This sensitivity level may be taken into account when verifying the identity of the user at operation 308 by averaging the confidence of each classifier in the classification of a current user of the second computer system 204b (e.g. by calculating the mean of the classifier scores) and determining whether this average is above or below the predetermined threshold. However, it will be appreciated that other methods of accounting for a sensitivity level associated with the authentication request may be used instead.

FIG. 4 is a flowchart that schematically illustrates a method 400 for authenticating a user 202 to a remote computer system, such as authentication server 206.

The remote computer system is arranged to authenticate the user using the method 300 as described above in relation to FIG. 3 based on an identity of the user 202 that is provided in an authentication request received from the first computer system 204a, one or more authentication factors including at least one “possession” factor that is obtained from the second computer system 204b and an auxiliary authentication factor.

This method 400 may be performed by any suitable computer system 100 belonging to the user 202 from which measurements of the user's behavioral biometrics can be collected and used to ascertain whether the user 202 is currently in possession of the computer system 100. As will be discussed in more detail below (and as will be appreciated from the foregoing discussion of FIG. 3), this method 400 may be performed by the second computer system 204b or by a further computer system, such as the third computer system 204c, and, in some cases, different versions of method 400 may be performed by both the second computer system 204b and one or more further computer systems.

At an operation 410, the method 400 provides an auxiliary authentication factor for use by the remote computer system to verify an identity of the user. This auxiliary authentication factor comprises data derived from one or more behavioral biometrics and can be used by the remote computer system to verify that the second computer system 204b from which the ‘possession’ factor was obtained is in the possession of the correct user (i.e. that is that it is in the possession of the user identified in the authentication request).

Where the method 400 is performed by the second computer system 204b itself (that is, by the computer system that provides a ‘possession’ factor for the authentication scheme), the auxiliary authentication factor may be provided directly to the remote computer system to allow the authentication to take place. In some cases, the auxiliary authentication factor may be sent together with the ‘possession’ factor, possibly in addition to any other authentication factors used by the authentication scheme that are to be provided by the second computer system 204b. However, in other cases, the auxiliary authentication factor may be transmitted separately from the other authentication factors. For example, the possession factor may be a OTP that the user reads and enters into the first computer system 204a to be sent to the authentication server 206 via a first communication channel whilst the auxiliary authentication factor is sent by the second computer system 204b to the authentication server 206 via a different second communication channel.

In some cases, where the method 400 is performed by the second computer system 204b, the data for the auxiliary authentication factor may be based on data derived from measurements of one or more behavioral biometrics for a current user of the second computer system 204b. These measurements may be used to verify that the current user of the second computer system 204b is the user indicated in the authentication request, as discussed in more detail earlier in relation to FIG. 3. These measurements may be provided with the auxiliary authentication factor to allow the authentication server 206 to verify that the current user of the second computer system 204b is the correct user. Alternatively, the measurements may be further processed by the second computer system 204b. For example, a continuous authentication process based on behavioral biometrics may be operable on the second computer system 204b to continuously (or at least periodically or sporadically) determine an identity of a current user. This identity may be provided with the auxiliary authentication factor to allow the authentication server 206 to verify that the user indicated by the auxiliary authentication factor is the correct user (i.e. the user associated with the authentication request). As yet a further example, the authentication server 206 may send a request for the second computer system 204b to verify the identity of the user that is being authenticated. In this example the authentication server 206 may supply either an identity of the user that is being authenticated or a behavioral biometric profile of the user that is being authenticated. The second computer system 204b may then determine whether a current user of the system matches the specified user identity or the supplied behavioral biometric profile and return an indication of the result back to the authentication server 206. In this example, the indication may simply be a positive indication, where the current user is determined to match the user identity or behavioral biometric profile provided by the authentication server, or a negative indication otherwise. Such an indication may therefore form the auxiliary authentication factor in such examples.

In some cases, where the method 400 is performed by the second computer system 204b, the data that is provided for the auxiliary authentication factor may include data based on measurements of the one or more behavioral biometrics by one or more further computer systems that are associated with the user, such as the third computer system 204c. As discussed in relation to FIG. 3, an assumption may be made that certain computer systems belonging the user are likely to be co-located. This means that when one computer system, such as the third computer system 204c is lost or stolen, it is likely that another computer system that is typically co-located with the third computer system 204c, such as the second computer system 204b, will also have been lost or stolen. Therefore, the data based on the behavioral biometrics from the further computer systems may be used to augment the behavioral biometrics from the second computer system 204b to increase a confidence in the determination of the identity of a current user of the second computer system 204b. Alternatively, where no behavioral biometrics from the second computer system 204b are available, such as where the second computer system 204b is unable to measure its user's behavioral biometrics, the behavioral biometrics from the one or more further computer systems may be used instead. As will be appreciated from the preceding discussion of FIG. 3, this assumption may be strengthened by only using data based on behavioral biometrics measured by computer systems that are within a predetermined vicinity of the second computer system at the time the authentication is occurring. Accordingly, in such cases, the method 400 may identify one or more further computer systems that are associated with the user (e.g. the correct owner of the second computer system 204b) which are located within a predetermined vicinity of the second computer system. The predetermined vicinity may be a certain distance, such as being within 1, 2, 5, 10, 25 or 50 meters of the second computer system 204b. Alternatively, the predetermined vicinity may require that each of the one or more further computer systems is within communication range of the second computer system 204b via a short-distance communication technology such as Bluetooth or being connected to the same network (e.g. being connected to the same WiFi hotspot). Having identified devices that are within the predetermined vicinity (e.g. by scanning for devices that are known to be owned by the user which are present on a local network), the second computer system 204b may then send requests to each of the further computer systems, requesting that they provide the auxiliary authentication factor. The method 400 then receives copies of the auxiliary authentication factor from each of the further computer systems, wherein each copy of the auxiliary authentication factor comprises data derived from measurements of the one or more behavioral biometrics for the current user of the device that provided it. The method 400 may then simply forward this data on to the authentication server as the auxiliary authentication factor (in which case each copy of the auxiliary authentication factor received from the one or more further computer systems forms a portion of the auxiliary authentication factor that is sent to the authentication server 206. Alternatively, the method 400 may process the data itself, for example to combine all of the data to provide a single indication of an identity that is considered to be currently in possession of the second computer system 204b, possibly together with an indication of a confidence in that determination (although, it will be appreciated that in other cases, no such confidence may be indicated).

In providing the auxiliary authentication factor to the second computer system 204b, the further computer systems may also be operating according to their own implementation of method 400. In which case, the auxiliary authentication factor provided at operation 410 is provided to the second computer system 204b in response to a request from the second computer system 204 for the auxiliary authentication factor.

In other cases where the method 400 is performed by a further computer system, the operation 410 may provide the auxiliary authentication factor to the authentication server 206 in response to a request for the auxiliary authentication factor received from the authentication server 206 (as already discussed in relation to FIG. 3).

In a similar manner to that discussed in relation to the performance of method 400 by the second computer system 204b, when the method 400 is performed by a further computer system, the data for the auxiliary authentication factor may be generated as part of a continuous authentication mechanism running on the further computer system. For example, a continuous authentication may be continuously (or at least periodically or sporadically) determine an identity of a current user of the further computer system and that identity may be provided as the auxiliary authentication factor by the further computer system.

Whilst the foregoing description has discussed the use of the auxiliary authentication factor in relation to a system in which the authentication is performed by an authentication server 206 operating according to method 300, it will be appreciated that embodiments of the disclosure may also be applied in situations where the authentication is performed by computer systems other than authentication server 206. For example, the first computer system 204a may operate according to method 300 to authenticate a user locally.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example. Suitably, the computer program is stored on a carrier medium in machine or device readable form, for example in solid-state memory, magnetic memory such as disk or tape, optically or magneto-optically readable memory such as compact disk or digital versatile disk, etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure. It will be understood by those skilled in the art that, although the present disclosure has been described in relation to the above described example embodiments, the disclosure is not limited thereto and that there are many possible variations and modifications which fall within the scope of the disclosure. The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for authenticating a user, the method comprising:
receiving an authentication request from a first computer system, the authentication request comprising an indication of an identity of the user to be authenticated;
receiving one or more authentication factors for verifying the identity of the user, the one or more authentication factors comprising at least one authentication factor obtained from a second computer system associated with the user having the indicated identity;
receiving an auxiliary authentication factor, the auxiliary authentication factor comprising data for verifying that the second computer system is currently in the possession of the user having the indicated identity; and
verifying the identity of the user based on the one or more authentication factors and the auxiliary authentication factor.

2. The method of claim 1, further comprising requesting the auxiliary authentication factor in response to determining that the authentication request is associated with a level of risk that exceeds a predetermined threshold.

3. The method of claim 2, wherein the determination that the authentication request is associated with the level of risk that exceeds the predetermined threshold is based on either one or both of: a time of the request; or a location of the request.

4. The method of claim 1, wherein the data comprises data derived from one or more behavioral biometrics.

5. The method of claim 4, wherein:
the data is, at least partially, derived from measurements of the one or more behavioral biometrics for a current user of the second computer system; and
the auxiliary authentication factor is, at least partly, received from the second computer system.

6. The method of claim 4, wherein the data is, at least partially, derived from respective measurements of the one or more behavioral biometrics for a respective current user of one or more further computer systems associated with the user having the identity indicated by the authentication request.

7. The method of claim 6, wherein the auxiliary authentication factor is, at least partly, received from each of the one or more further computer systems.

8. The method of claim 6, wherein the one or more further computer systems associated with the user having the indicated identity are located within a predetermined vicinity of the second computer system.

9. The method of claim 8, further comprising:
identifying the one or more further computer systems associated with the user having the indicated identity that are located within the predetermined vicinity of the second computing device; and
sending requests for the auxiliary authentication factor to each of the further computer systems,
wherein the auxiliary authentication factor is received in response to the requests and includes data from each of the further computer systems.

10. The method of claim 1, wherein the data comprises an indication of an identity of a current user of a computer system as determined by a continuous authentication mechanism operating on that computer system.

11. The method of claim 10, wherein the data comprises a respective indication of a confidence in the identity of the current user of the computer system.

12. The method of claim 1, wherein the verification of the identity of the user is further based on a sensitivity level associated with the authentication request, the sensitivity level indicating a required level of confidence in the identity of the user that is required for the identity indicated in the authentication request to be verified.

13. The method of claim 1, wherein the at least one authentication factor obtained from the second computer system is received from the first computer system.

14. The method of claim 1, wherein the at least one authentication factor obtained from the second computer system is received from the second computer system.

15. The method of claim 1, wherein the authentication of the user is for controlling access to a resource, the method further comprising allowing access to the resource in response to verifying the identity of the user.

16. A computer implemented method for authenticating a user to a remote computer system, the method comprising:
providing an auxiliary authentication factor for use by the remote computer system to verify an identity of the user indicated in an authentication request from a first computer system based on one or more authentication factors and the auxiliary authentication factor,
wherein the one or more authentication factors comprise at least one authentication factor obtained from a second computer system associated with the user having the indicated identity and the auxiliary authentication factor comprises data for verifying that the second computer system is currently in the possession of the user having the indicated identity.

17. The method of claim 16, wherein the method is performed by the second computer system and the auxiliary authentication factor is provided to the remote computer system.

18. The method of claim 17, further comprising providing the at least one authentication factor to the remote computer system.

19. The method of claim 16, wherein the data comprises data derived from one or more behavioral biometrics.

20. The method of claim 19, further comprising:
identifying one or more further computer systems associated with the user having the indicated identity that are located within a predetermined vicinity of the second computer system;
sending requests for the auxiliary authentication factor to each of the further computer systems; and
receiving, from each of the further computer systems, in response to the requests, data derived from respective measurements of the one or more behavioral biometrics for a current user of that computer system,
wherein the data provided for the auxiliary authentication factor is based, at least in part, on the data received from the one or more further computer systems.

21. The method of claim 19, wherein the data provided for the auxiliary authentication factor is based, at least in part, on data derived from measurements of the one or more behavioral biometrics for a current user of the second computer system.

22. The method of claim 16, wherein the method is performed by a further computer system in response to a request for an auxiliary authentication factor to be provided.

23. The method of claim 16, wherein the data is generated by a continuous authentication mechanism.

24. A computer system comprising a processor and a memory storing computer program code for carrying out the method of claim 1.

25. A non-transitory computer-readable storage medium storing a computer program which, when executed by one or more processors, is arranged to cause the one or more processors to carry out the method of claim 1.
